(19) United States
(12) Patent Application Publication
(10) Pub. No.: US 2012/0328767 A1
(43) Pub. Date: Dec. 27, 2012

(54) POTATO BOX STORE CHEMICAL TREATMENTS

(75) Inventors: John M. Forsythe, Nampa, ID (US); Henry John Duncan, Glasgow (GB); Curtis Lee Eames, Meridian, ID (US)

(73) Assignee: 1,4 GROUP, INC., Meridian, ID (US)

(21) Appl. No.: 13/530,458

(22) Filed: Jun. 22, 2012

Related U.S. Application Data
(60) Provisional application No. 61/499,771, filed on Jun. 22, 2011.

(51) Int. Cl. A23B 7/144; B65D 81/28

(52) U.S. Cl. 426/654; 220/62.13; 206/216; 383/102

(57) ABSTRACT

Chemical treatment systems and devices structured and adapted to provide chemical vapor of a sprout-inhibiting chemical to tubers stored in boxes in box storage facilities.

### CROSS-REFERENCE TO RELATED APPLICATION

This application claims the benefit of U.S. Provisional Patent Application Ser. No. 61/499,771, filed Jun. 22, 2011, the disclosure of which is hereby incorporated herein in its entirety by this reference.

### TECHNICAL FIELD

Chemical treatment systems for inhibiting sprouting of potatoes stored in box storages.

### BACKGROUND OF INVENTION

Potatoes are often stored from harvest time until sale for many months. During this storage time, it is often necessary to treat the potatoes with various types of chemicals, e.g., sprout inhibitors such as isopropyl chlorophenylcarbamate (CIPC), 1,4 dimethyl naphthalene (1,4 DMN) and the like, as well as pesticides, fungicides and the like.

Potatoes are generally stored in two types of storages: bulk storages where the potatoes are present as a huge pile; and box storages where the potatoes are present in large, slat-type boxes, approximately 4×4×6 feet long stacked several rows deep and up to eight boxes high.

Treatment of bulk storage with an aerosolized chemical to deposit droplets or particles of the chemical on substantially every stored potato has been very effective. See U.S. Pat. Nos. 5,936,660, 6,068,888, and 4,887,525. Aerosols are generally provided by thermofoggers; see U.S. Pat. No. 6,322,002, and the treatment process is often referred to as “fogging.”

Fogging of potatoes with CIPC is typically delayed until after the potatoes have suberized, but before a bulk pile has settled. The timing of CIPC fog application is due to the fact that CIPC interferes with suberization and that an aerosol (fog) does not move effectively through the potato pile after it has settled (compressed).

These same constraints apply to box stored potatoes. However, an additional problem exists with box-type storages in that the aerosol (fog) tends to move between the boxes (channeling) rather than through the boxes so as to provide contact between individual potatoes within the box-type storages and the chemical droplets/particles. Given these circumstances, box storages are often over-treated with aerosols of CIPC in an effort to provide sufficient coverage with the chemicals in order to prevent unwanted sprouting.

As a result of this over-treatment, regulatory agencies have set maximum residue levels (MRLs) in many jurisdictions such as, for example, the United Kingdom (UK). The UK MRL of 10 ppm cannot be present on any stored potato. This maximum, given the uneven distribution in box storages, is difficult to meet.

### BRIEF SUMMARY OF THE INVENTION

A particular embodiment of the invention is drawn to a porous media infused with CIPC coated with a humidity-dissolvable chemical.

Another embodiment is drawn to a box-store structure for holding potatoes having slat-like members. The structure includes an adherent base coating upon at least one of slat-like members, the coating comprising minute particles of CIPC. The base coating is substantially covered with an overcoating of a humidity-dissolvable coating. Alternatively, CIPC particles or media infused with CIPC may be incorporated into an adherent tape that can be stuck to a portion of a box. The tape preferably decomposes, but CIPC particles or media may be exposed on the surface of the tape.

A specific embodiment of a slat-type box for storing potatoes therein includes a system integral with said box, said system infused with CIPC adapted and structured to provide CIPC vapor in a delayed release manner.

Yet another embodiment includes a CIPC infused porous media sized and adapted to provide sufficient CIPC vapor to inhibit sprouting of potatoes in a storage box containing up to about 1000 kg of potatoes.

A particular embodiment of the invention includes a fabric, porous sack containing a porous media having an extended surface, said porous media infused with CIPC over a substantial portion of the extended surface of said media.

### BRIEF DESCRIPTION OF THE SEVERAL VIEWS OF THE DRAWINGS

In the drawings, in which various features of embodiments of the present invention are depicted:

FIG. 1 illustrates a potato box containing a rope-like material infused with CIPC, according to a particular embodiment of the invention;

FIG. 2 illustrates a cover mat formed of porous rope that may be infused with CIPC, according to a particular embodiment of the invention;

FIGS. 3-6 illustrate a device having a central cylinder with projecting hollow arms that are contained CIPC-infused porous media, according to a particular embodiment of the invention; and

FIGS. 7 and 8 illustrate a canister containing an infused porous media, according to a particular embodiment of the invention.

### DETAILED DESCRIPTION OF INVENTION

The instant invention relates to methods and systems for treating box-stored potatoes with vapor via sublimation of CIPC present in proximity to potatoes stored in individual boxes.

Sublimation of solid CIPC at storage temperatures of 5° C. to about 10° C. provides sufficient vapor to affect sprouting of potatoes during storage. Preferably, a source of CIPC is available in proximity to each individual box in a storage facility. The CIPC source may be inside a box or attached to the box or positioned very closely to each box.

The quantity of CIPC in a CIPC source (device) should be sufficient to provide enough CIPC vapor to maintain the quantity of potatoes in a box to be treated in a non-sprouting condition during a predetermined storage period.

It has been determined experimentally that CIPC at about 10° C. will sublimate to provide a vapor concentration of about 0.1 microgram/liter (1 milligram/cubic meter) of headspace. This quantity of CIPC vapor has further been determined to be sufficient to maintain potatoes in a non-sprouting condition.

It is also known that a deposit of 2 ppm of CIPC particles on potatoes via fogging is sufficient to inhibit sprouting. Using this latter figure, a box containing 1000 kg of potatoes would require a CIPC source in an amount of 0.002 kg/box or 2 gms/box. Getting CIPC particles into boxes via aerosolization or fogging has been a challenge and generally not very successful, with excessive fogging applications of up to 60 ppm during a storage season. Thus, the introduction of a subliming, extensive surface of CIPC upon a porous media provides a more effective, more efficient way to maintain box stored potatoes in a non-sprouting condition.

Various methods and systems may be utilized to provide an extended surface of solid CIPC in or near to each box, preferably, in a box storage. Systems in which very thin layers or groups of CIPC particles are placed upon the surface of a porous material having an extended surface are particularly useful in the instant invention.

For example, numerous inorganic materials, such as silica gel, alumina, diatomaceous earth, and the like, have large surface areas per unit volume. Infusing such porous material with CIPC to produce a very thin layer of CIPC upon the extended surface of each porous particle can provide an effective source of CIPC.

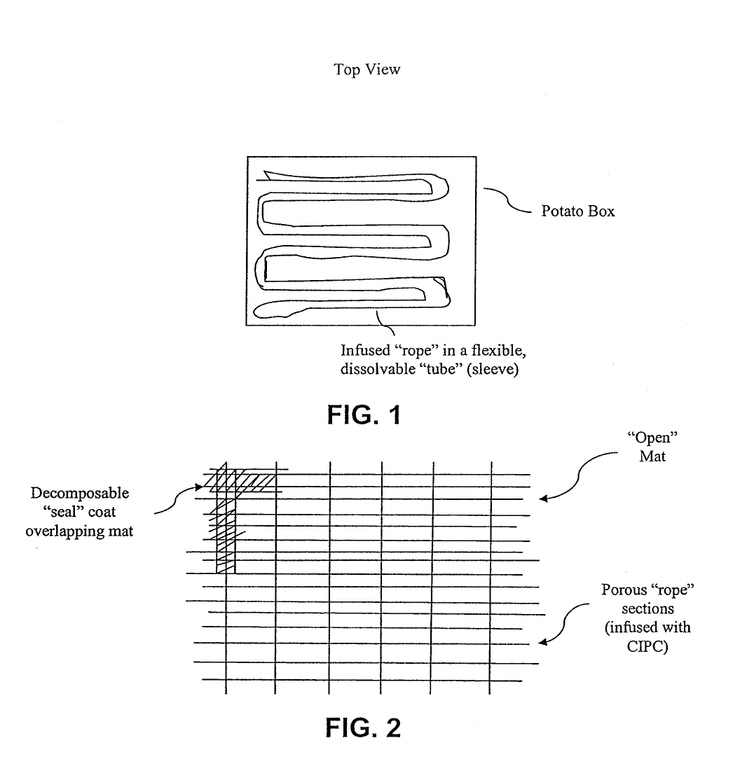

FIG. 1 illustrates a particular embodiment of the invention, wherein a potato box containing a rope-like material infused with CIPC. The CIPC may be infused into the rope from a solution of CIPC, an aerosol of CIPC or from molten CIPC. The infused rope may be encased in a sleeve of a decomposable film to provide a delayed exposure of CIPC, if such delayed exposure is desired.

A CIPC-infused rope, with or without a sleeve, may be disposed onto the bottom of a box as it is being filled with potatoes or disposed under each box after the boxes are filled, stacked and suberization completed. No decomposable sleeve may be needed if the infused rope is placed under stacked boxes after suberization is completed.

A natural-chimney effect exists within a box of stored potatoes, caused generally by the heat produced from the respiring potatoes. Thus, porous rope infused with CIPC placed in a box at its bottom or immediately below the box bottom can provide CIPC vapor that is “sucked” up through the box of potatoes.

FIG. 2 illustrates another embodiment of the invention, wherein a cover mat is formed of porous rope that may be infused with CIPC. The mat may be covered within a film of decomposable material, especially if the material is to be placed within a box as potatoes are being put into the box. The mat may also, without any film covering, be inserted between and underneath stacked boxes, especially after suberization is complete.

Decomposable film as coatings may be formed from any suitable material known in the art, such as, for example, polyvinyl alcohol, polyvinyl pyrrolidone, hydroxyl methylcellulose, starch material, agar and the like. The films can be structured and adapted to decompose in the high humidity existing in a potato storage.

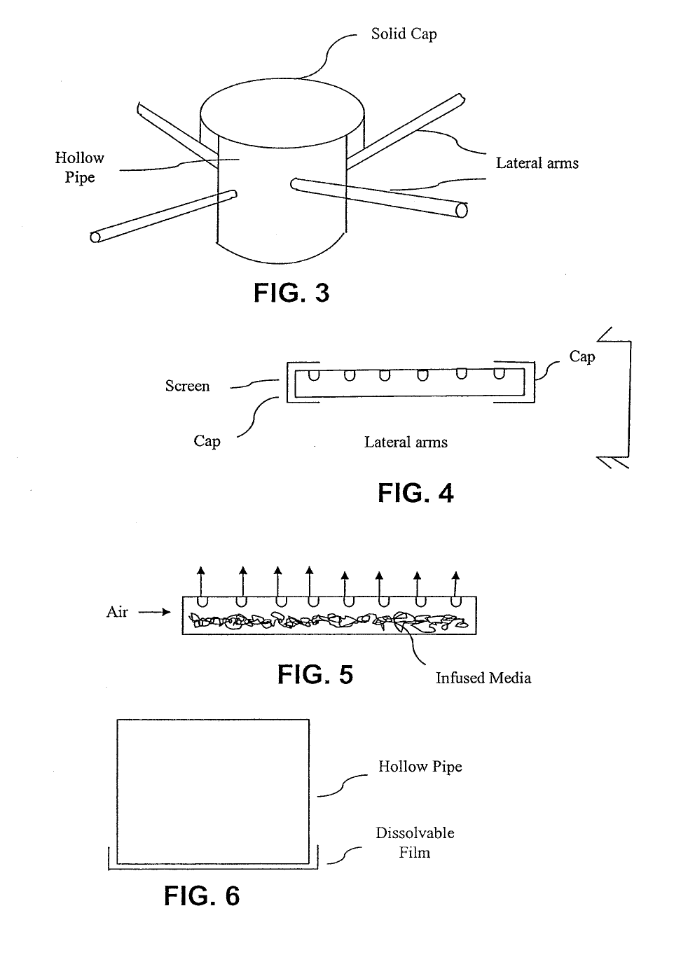

Another embodiment of a structure suitable for installation in a box before it is filled is illustrated in FIGS. 3, 4, 5 and 6. The device has a central cylinder with projecting hollow arms that contain CIPC-infused porous media, such as alumina, or other inorganic media, such as porous fibrous material. The device can be generally structured to fit upon the bottom of box before potatoes are introduced. The central cylinder can be positioned in the bottom box of a stack of boxes to be adjacent or over any storage air circulation vent. Such a device is advantageous in that it can be easily filled with infused porous media and is easy to install and to remove at the end of a season without any difficult clean-up.

A decomposable film may be placed at the base of the central cylinder with a cap at its top end. This arrangement can provide a delayed release of vapor, if desired, and can direct air up through the cylinder and outward through the lateral arms and over and around the infused porous media to vent vapors through the media in the spider arms.

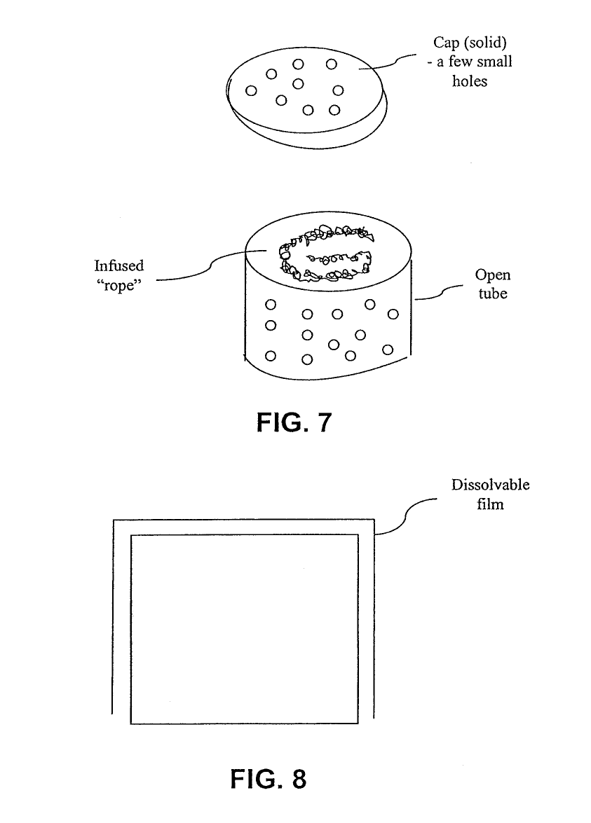

FIGS. 7 and 8 illustrate another embodiment that includes a canister containing an infused porous media, such as media of a fibrous nature. The bottom of the canister can be open with venting ports in its side and lid. A removable or decomposable film may be used to seal the open bottom of the canister until sublimation of infused CIPC into the porous media is desired.

The porous media may contain only CIPC or CIPC in conjunction with a solvent that is not harmful to stored potatoes or in a solvent having beneficial attributes for the stored potatoes. The solvents may include methanol, isopropyl alcohol, propylene glycol, nonanol and the like, as well as additional sprout-inhibiting chemical(s) such as 1,4 dimethyl naphthalene, carvone, and essential volatile oils such as clove oil, mint oil, and the like.

What is claimed is:

1. A porous media infused with CIPC coated with a coating of a humidity-dissolvable chemical.

2. The porous media of claim 1, wherein said dissolvable chemical is a film of a polymerical material.

3. The porous media of claim 2, wherein the polymeric material is PVA (polyvinyl alcohol).

4. The porous media of claim 1, wherein said media is contained within a porous/permeable structure.

5. The porous media of claim 4, wherein the porous/permeable structure is a flexible fabric sack.

6. The porous media of claim 5, wherein the flexible fabric sack is contained/infused within a humidity dissolvable chemical film.

7. A box-store structure for holding potatoes having slat-like members comprising:
an adherent base coating upon at least one of slat-like members said coating comprising minute particles of CIPC; and
an overcoating of a humidity-dissolvable coating substantially covering said base coating.

8. A slat-type box for storing potatoes therein, comprising:
a system integral with said box, said system infused with CIPC adapted and structured to provide CIPC vapor in a delayed release manner, comprising:
tapes adhered to said slats, said tapes containing CIPC.

9. A CIPC infused porous media sized and adapted to provide sufficient CIPC vapor to inhibit sprouting of potatoes in a conventionally sized storage box for storing potatoes in a box storage.

10. The porous media of claim 9, wherein said media is structured to fit within or under said storage box.

11. The porous media of claim 10, wherein said porous media is in the form of a porous mat.

12. The porous media of claim 10, wherein said porous media is contained within a porous container (sack or canister).

13. A fabric, porous sack containing a porous media having an extended surface, said porous media infused with CIPC over a substantial portion of the extended surface of said media.

14. The sack of claim 13, wherein said CIPC is present in a predetermined quantity.

15. The sack of claim 13, wherein said sack has a length of retrieval cord attached thereto.

16. The sack of claim 13, wherein said sack is sized and adapted to fit within a ventilation duct of a potato storage facility.

17. The sack of claim 13, wherein said porous media is an inorganic media having an extensive surface area per unit volume.

18. The sack of claim 17, wherein said inorganic media is alumina or silica gel.

19. The sack of claim 17, wherein at least about half the extended surface area of said porous media is infused with CIPC.
